(19) United States
(12) Patent Application Publication
(10) Pub. No.: US 2024/0382356 A1
(43) Pub. Date: Nov. 21, 2024

(54) PERCEPTION-BASED ALERT SYSTEMS AND CONTROLLERS FOR DETECTING SAFE USE CONDITIONS OF A WHEELCHAIR ACCESS DEVICE IN A WHEELCHAIR ACCESSIBLE VEHICLE

(71) Applicant: The Braun Corporation, Winamac, IN (US)

(72) Inventors: Andrew Henseleit, Noblesville, IN (US); Joseph Miller Geddes, Zionsville, IN (US); Adam Wojdyla, Winamac, IN (US)

(21) Appl. No.: 18/665,684

(22) Filed: May 16, 2024

Related U.S. Application Data
(60) Provisional application No. 63/502,439, filed on May 16, 2023.

(51) Int. Cl. A61G 3/06; B60Q 9/00

(52) U.S. Cl. CPC A61G 3/062; B60Q 9/00

(57) ABSTRACT

The present disclosure relates generally to a perception sensor, including but not limited to an absolute position sensor, for detecting the angle of a wheelchair access device in a wheelchair accessible vehicle. The subject technology improves the safety of wheelchair access devices, such as wheelchair lifts and ramps, in traditional wheelchair accessible vehicles during ingress and egress of a passenger by alerting a vehicle operator or caretaker of unsafe angles and conditions. The subject technology may also be useful in autonomous vehicles (AV) for enabling automatic operation of a wheelchair access device, such as a ramp or lift, and facilitate the safe loading and unloading of a passenger seated in a wheelchair.

### CROSS-REFERENCE TO OTHER APPLICATIONS

This application claims priority to U.S. Provisional Patent Application No. 63/502,439, filed 16 May 2023, the contents of which are incorporated herein by reference. This application also incorporates by reference PCT Patent Application No. PCT/US24/29565, filed 16 May 2024.

### FIELD OF THE DISCLOSURE

The present application relates to a wheelchair accessible vehicle for transporting one or more wheelchairs and passengers seated in their wheelchair. More particularly, the present disclosure relates generally to perception sensors for detecting an angle of a wheelchair access device, such as a wheelchair lift and a wheelchair ramp, in a wheelchair accessible vehicle. The subject technology improves the safety of wheelchair access devices in traditional vehicles, by alerting the wheelchair passenger and/or vehicle operator of unsafe angles. The subject technology may also be useful in autonomous vehicles (AV) not only to provide alerts for the vehicle occupants, but also to inform the AV's automatic ingress/egress operations of the current status of the wheelchair access device.

### BACKGROUND

Automobile manufacturers do not currently mass-produce passenger motor vehicles specifically designed to transport passengers having physical limitations, either as a driver or as a non-driving passenger. Consequently, mass-produced passenger vehicles are modified, or retrofitted, by a number of aftermarket companies dedicated to supplying vehicles to physically limited passengers. Such vehicles can be modified by removing certain parts or structures within a vehicle and replacing those parts with parts specifically designed to accommodate the physically limited passenger. For example, in one configuration, a van or bus is retrofitted with a wheelchair access device, such as a lift or ramp, to enable a physically limited individual using a wheelchair to enter and exit the vehicle without the assistance of another individual. In these modified vehicles, vehicle operators must rely upon their own senses to ensure compliance with safe loading conditions as presented in the wheelchair access device manufacturer's operation manuals. Whether due to insufficient training, limited reaction times, or distractions, vehicle operators are not infallible. Accidents can and do happen during ingress and egress of wheelchair passengers. Accordingly, the shortcomings of the prior art can be addressed by the presently disclosed perception sensing systems that can detect unsafe loading conditions and provide real time/immediate alerts to the vehicle operator and passengers.

The perception sensing systems of the present application have applicability in what may believe is the next generation of wheelchair accessible vehicles, autonomous vehicles (AVs). The prior art contemplate “automatic” egress and ingress operations in AVs. However, the prior art disclosures are vague in many respects and lack sufficient disclosure to make and safely use wheelchair access devices in autonomous wheelchair accessible vehicle. As one example, the prior art disclosures do not include or contemplate safeguards or logic to ensure that the wheelchair access device (e.g., ramp) is oriented correctly for safe use by a wheelchair passenger. The shortcomings of the prior art AVs therefore can be addressed by the presently disclosed perception sensing systems that can detect unsafe loading conditions, provide real time/immediate feedback to the vehicle control systems that are performing an automatic ingress or egress operation, and generate appropriate safety interlocking of vehicle and accessibility components (e.g., to prevent release of the wheelchair when the wheelchair access device is not safe for use).

As just one example, the technology of the present application has use in the AVE disclosed in U.S. Pat. No. 11,523,950 B2 and US. Patent Application Publications US2021/0370976A1 and US2022/0234627 A1, the contents of which are incorporated herein in their entirety. As disclosed therein and relevant to the present disclosure:

Autonomous vehicles (AVs) are vehicles having computers and control systems that perform driving and navigation tasks that are conventionally performed by a human driver. Automation technology in the autonomous vehicles enables the vehicles to drive on roadways and to accurately and quickly perceive the vehicle's environment, including obstacles, signs, and traffic lights. The vehicles can be used to pick up passengers and drive the passengers to selected destinations. As AV technologies continue to advance, ride-sharing services will increasingly utilize AVs to improve service efficiency and safety. However, for effective use in ride-sharing deployments, AVs will be required to perform many of the functions that are conventionally performed by human drivers, such as performing navigation and routing tasks necessary to provide a safe and efficient ride service. Such tasks may require the collection and processing of large quantities of data using various sensor types, including but not limited to cameras and/or Light Detection and Ranging (LiDAR) sensors disposed on the AV.

For passengers who utilize wheelchairs, entering and exiting vehicles requires many different steps and procedures, including opening a door of the vehicle, deploying a ramp, securing/releasing the wheelchair in the cabin of the vehicle, stowing the ramp, closing the vehicle door, etc. In conventional ridesharing arrangements, human drivers assist passengers with accessibility into an out of the vehicle. For example, human drivers routinely help passengers load/unload and secure accessibility equipment, such as a wheelchairs and other mobility devices. Because human drivers are absent from autonomous vehicle (AV) deployments, there exists a need to provide automated support for the ingress/egress for passengers with special accessibility needs.

In addition, conventional rideshare vehicles are often used to provide rides to destinations with primary drop-off locations on private property. For example, drop-off locations can include hotel lobbies off the main road and houses at the end of long driveways. Additionally, businesses may have main drop-off zones on private property, and some locations may have preferred handicap entrances. However, autonomous vehicles generally do not travel on private property and do not have high fidelity maps of these locations.

Aspects of the prior art technology address the foregoing limitations by providing perception supporting hardware features that facilitate the loading and unloading (ingress/egress) of mobility devices, such as wheelchairs and/or personal scooters. In some aspects, the prior art technology includes AV sensors, e.g. cameras and/or Light Detection and Ranging (LiDAR) sensors that are configured to provide perception capabilities to the computing systems of the wheelchair accessible vehicle (WAV). In some prior art approaches, an AV of the disclosed technology can include reference markers that are disposed on or around certain AV features, such as on a wheelchair ramp, to facilitate AV perception of the accessibility equipment loading/unloading process. Additionally, a restraint system of the AV can be configured to automatically secure one or more pieces of equipment, such as a wheelchair, before a ride is commenced.

Other aspects of the prior art technology address the limitations of vehicles for wheelchair passengers by providing an application on a mobile device for wheelchair passengers to send requests to and/or control wheelchair-accessible systems on an autonomous vehicle. In some aspects of the prior art, a remote computing system may receive a request for a wheelchair-accessible autonomous vehicle (WAV) to execute an ingress function, such as deployment of a wheelchair ramp by the WAV. Furthermore, in response to the request, the remote computing system may send an ingress command to the WAV, such that the ingress command includes instructions to cause the WAV to execute the ingress function. Additionally, the remote computing system may receive feedback from the WAV indicating sensor data associated with the wheelchair ramp and status information associated with the ingress function.

Yet other aspects of the prior art technology provide systems and methods for user-specified location-based autonomous vehicle behavior zones. Public-facing tools can be provided for creation of custom behavior zones, providing a more tailored experience for passengers as well as businesses. Custom behavior zones allow passengers to request or select a specific pick-up/drop-off location on private property, including the identification of wheelchair-accessibility pick-up/drop-off locations.

FIG. 1 illustrates an example prior art system environment 100 that can be used to facilitate AV dispatch and operations, according to some aspects of both the prior art and presently disclosed technology. Autonomous vehicle 102 can navigate about roadways without a human driver based upon sensor signals output by sensor systems 104-106 of autonomous vehicle 102. Autonomous vehicle 102 includes a plurality of sensor systems 104-106 (a first sensor system 104 through an Nth sensor system 106). Sensor systems 104-106 are of different types and are arranged about the autonomous vehicle 102. For example, first sensor system 104 may be a camera sensor system and the Nth sensor system 106 may be a Light Detection and Ranging (LIDAR) sensor system. Other exemplary sensor systems include radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems such as Global Positioning System (GPS) receiver systems, accelerometers, gyroscopes, inertial measurement units (IMU), infrared sensor systems, laser rangefinder systems, ultrasonic sensor systems, infrasonic sensor systems, microphones, or a combination thereof. While four sensors 180 are illustrated coupled to the autonomous vehicle 102, it is contemplated in the prior art that more or fewer sensors may be coupled to the autonomous vehicle 102.

Autonomous vehicle 102 further includes several mechanical systems that are used to effectuate appropriate motion of the autonomous vehicle 102. For instance, the mechanical systems can include but are not limited to, vehicle propulsion system 130, braking system 132, and steering system 134. Vehicle propulsion system 130 may include an electric motor, an internal combustion engine, or both. The braking system 132 can include an engine brake, brake pads, actuators, and/or any other suitable componentry that is configured to assist in decelerating autonomous vehicle 102. In some cases, braking system 132 may charge a battery of the vehicle through regenerative braking. Steering system 134 includes suitable componentry that is configured to control the direction of movement of the autonomous vehicle 102 during navigation. Autonomous vehicle 102 further includes a safety system 136 that can include various lights and signal indicators, parking brake, airbags, etc. Autonomous vehicle 102 further includes a cabin system 138 that can include cabin temperature control systems, in-cabin entertainment systems, etc.

The autonomous vehicle 102 further includes a wheelchair accessibility system 140 that can include various electrical and mechanical systems including, but not limited to, doors, ramps, restraint systems, etc. Wheelchair accessibility system 140 is configured to assist passengers utilizing wheelchairs during ingress and egress of the autonomous vehicle 102.

Autonomous vehicle 102 additionally comprises an internal computing system 110 that is in communication with sensor systems 180 and systems 130, 132, 134, 136, and 138. Internal computing system 110 includes at least one processor and at least one memory having computer-executable instructions that are executed by the processor. The computer-executable instructions can make up one or more services responsible for controlling autonomous vehicle 102, communicating with remote computing system 150, receiving inputs from passengers or human co-pilots, logging metrics regarding data collected by sensor systems 180 and human co-pilots, etc.

Internal computing system 110 can include a control service 112 that is configured to control operation of vehicle propulsion system 130, braking system 132, steering system 134, safety system 136, and cabin system 138. Control service 112 receives sensor signals from sensor systems 180 as well communicates with other services of internal computing system 110 to effectuate operation of autonomous vehicle 102. In some embodiments, control service 112 may carry out operations in concert one or more other systems of autonomous vehicle 102. Internal computing system 110 can also include constraint service 114 to facilitate safe propulsion of autonomous vehicle 102. Constraint service 114 includes instructions for activating a constraint based on a rule-based restriction upon operation of autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of control service 112.

The internal computing system 110 can also include communication service 116. The communication service 116 can include both software and hardware elements for transmitting and receiving signals from/to the remote computing system 150. Communication service 116 is configured to transmit information wirelessly over a network, for example, through an antenna array that provides personal cellular (long-term evolution (LTE), 3G, 4G, 5G, etc.) communication.

In some embodiments, one or more services of the internal computing system 110 are configured to send and receive communications to remote computing system 150 for such reasons as reporting data for training and evaluating machine learning algorithms, requesting assistance from remoting computing system or a human operator via remote computing system 150, software service updates, ridesharing pickup and drop off instructions etc.

Internal computing system 110 can also include latency service 118. Latency service 118 can utilize timestamps on communications to and from remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, latency service 118 can enable other systems of autonomous vehicle 102 or a passenger to make necessary decisions or to provide the needed feedback.

Internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 102 regarding reporting data for training and evaluating machine learning algorithms, requesting assistance from remote computing system 150 or a human operator via the remote computing system 150, software service updates, rideshare pickup and drop off instructions, etc.

Remote computing system 150 includes an analysis service 152 that is configured to receive data from autonomous vehicle 102 and analyze the data to train or evaluate machine learning algorithms for operating the autonomous vehicle 102. The analysis service 152 can also perform analysis pertaining to data associated with one or more errors or constraints reported by autonomous vehicle 102. Remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

The remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

Remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

Remote computing system 150 can also include rideshare service 158 configured to interact with ridesharing applications 170 operating on (potential) passenger computing devices. Rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle to 102 go around an obstacle, change routes, honk the horn, etc. The ridesharing application 170 can also be configured to receive requests specifically for wheelchair-accessible autonomous vehicles 102. Similarly, ridesharing app 170 can also be configured to receive requests from a passenger for the autonomous vehicle 102 to perform a function and send the request to the rideshare service 158 of the remote computing system 150. The remote computing system 150 can then process the request and send commands to the communication service 116 of the internal computing system of the autonomous vehicle 102, so that the autonomous vehicle 102 can execute the request.

Remote computing system 150 can, in some cases, include at least one computing system 150 as illustrated in or discussed with respect to FIG. 10, or may include at least a subset of the components illustrated in FIG. 10 or discussed with respect to computing system 150.

FIG. 2 shows a prior art environment 200 in which an autonomous vehicle 102 has accessories to be wheelchair accessible. Accordingly, autonomous vehicle 102 is a wheelchair-accessible autonomous vehicle (WAV) 102. More specifically, WAV 102 has automatic doors 208, a wheelchair ramp 210, and a wheelchair restraint system 220. Thus, WAV 102 is configured to accommodate a wheelchair 250 of a passenger and/or a wheelchair passenger 250.

The automatic doors 208 are configured to receive commands from an internal computing system, such as the internal computing system 110, and/or a remote computing system, such as remote computing system 150. The doors 208 can, in response to receiving commands from the internal computing system and/or remote computing system, automatically open and/or close to allow passengers and objects to pass therethrough. For example, wheelchair passenger 250 may send, via an application on a mobile device, a request for the WAV to open doors to a remote computing system. In response to receiving the request, the remote computing system may then send a command to the internal computing system. In response to receiving the command, the internal computing system can then control the doors 208 to open and/or send a command to a system controlling the doors 208 to open the doors 208.

Like doors 208, wheelchair ramp 210 is configured to receive commands from the internal computing system 110 and/or the remote computing system 150. The wheelchair ramp 210 can, in response to receiving commands from the internal computing system and/or remote computing system, automatically load and/or unload to allow wheelchairs to be cross thereon.

Similarly, wheelchair restraint system 220 is configured to receive commands from the internal computing system 110 and/or the remote computing system 150. The wheelchair restraint system 220 can, in response to receiving commands from the internal computing system and/or remote computing system, automatically secure and/or release a wheelchair.

FIG. 3 and FIG. 4 show prior art environments 300a, 300b during various steps of restraining and/or securing the wheelchair 250.

More specifically, FIG. 3 illustrates the wheelchair and/or wheelchair passenger 250 in a cabin of the WAV 102. After the wheelchair passenger 250 has entered the cabin of the WAV 102, the ramp 210 may be loaded back onto WAV 102 and the doors 208 closed. Although not shown, the doors 208 may not be closed yet and/or the ramp may not be loaded yet. Although the wheelchair passenger 250 has entered the cabin of the WAV, the wheelchair restraint system 220 has not yet been engaged. The wheelchair passenger 250 may position the wheelchair in the cabin, such that the wheelchair restraint system 220 may, after being engaged, secure the wheelchair.

FIG. 4 illustrates the wheelchair and/or wheelchair passenger 250 secured by the wheelchair restraint system 220. Furthermore, wheelchair ramp 210 may be loaded back onto WAV 102 and the doors 208 closed. At this time, wheelchair passenger 250 may send information to WAV 102 indicating that the wheelchair passenger 250 is ready for WAV 102 to begin driving. In other words, after the wheelchair and/or wheelchair passenger 250 is properly secured by wheelchair restraint system 220, the doors 208 closed, and the wheelchair ramp 210 loaded, WAV 102 can begin driving.

FIG. 5 illustrates an example prior art accessibility system 200 that facilitates AV ingress/egress of a wheelchair, according to some aspects of both the prior art and presently disclosed technology. Accessibility system 200 includes communication module 202 that is communicatively coupled to ingress/egress perception module 204, and vehicle control module 206.

Communication module 202 can be responsible for receiving commands related to the operation of accessibility controls, such as to facilitate ingress/egress of a wheelchair ramp and/or enlist operations of an accompanying restraint system. By way of example, communications module 202 can be configured for communication with a mobile device and associated applications that can receive requests from a user/rider, and provide notifications to the rider. As such, communications module 202 can facilitate accessibility operations between wheelchair accessible AV, and various users/riders.

In turn, WAV ingress/egress perception module 204 can provide perception needed to track progress of the ingress/egress of accessibility equipment, such as by tracking progress in loading or unloading a wheelchair from an AV, for example, using a wheelchair ramp. As discussed in further detail below, perception functionalities performed by WAV ingress/egress perception module 204 can be facilitated by one or more visual cues/markers that are disposed at locations in the AV.

In conjunction with WAV vehicle controls module 206, WAV ingress/egress perception module 204 can provide functionality needed to automate the assistance process, for example by deploying a wheelchair ramp, tracking the progress of the conveyance of accessibility equipment into the AV, and securing the accessibility equipment using an automated restraint system (not shown).

FIG. 6 illustrates an example of a prior art automated wheelchair ingress/egress process 300. Process 300 begins with step 302 in which one or more visual reference features (e.g., one or more reflective markers) are identified (e.g. by a perception system of the AV) on at least one surface of the AV. In some approaches, multiple reference features of known locations can be used to ascertain the location of equipment within the AV, such as the deployment and retraction of a wheelchair ramp, as well as to track position/location information for one or more pieces of accessibility equipment and/or people boarding or exiting the AV cabin.

By way of example, location information may be ascertained about the wheelchair ramp position and/or a loading status of a wheelchair being loaded or unloaded from the AV based on visual obstructions between one or more of the reference features and one or more AV sensors (e.g. cameras and/or LiDAR sensors, etc.). Although visual markers can be used in some embodiments, it is contemplated in the prior art that the perception system of the prior art technology can be configured to perform tracking and location determinations using only AV sensors (e.g., cameras and/or LiDAR sensors, etc.).

In step 304, a ramp of the AV is automatically deployed to facilitate the ingress of one or more items of mobility equipment (e.g., a wheelchair). It is contemplated in the prior art that other aspects of the AV operation can also be automatically controlled, such as the opening and closing of one or more doors of the AV and/or the automatic harness/release of a restraint system, as discussed in further detail below.

In step 306, ingress of the mobility equipment (wheelchair) is tracked using the reference features. By way of example, visual obstruction of one or more reference features disposed on the wheelchair ramp may indicate a position of the wheelchair on the ramp. Tracking can also continue using one or more visual features that are disposed inside the AV cabin.

In step 308, the mobility equipment can be automatically secured within a cabin of the AV. Similar to step 306, the maneuver and automatic restraint of mobility equipment can be aided using location/position perception that is performed using one or more visual features. However, location/position tracking without the use of visual markers is contemplated. For example, tracking necessary to perform ingress/egress operations may be performed using AV sensor data that is provided to a machine-learning model.

FIG. 7 shows a prior art method 400 for assisting passenger ingress. Method 400 starts at step 402, in which a remote computing system receives a rideshare request to use a wheelchair-accessible autonomous vehicle (WAV). In some embodiments, the remote computing system receives and processes the rideshare request through a rideshare service, such as rideshare service 158.

At step 404, the remote computing system dispatches the WAV to a location of the passenger. In some embodiments, the remote computing system dispatches the WAV through a rideshare service, such as rideshare service 158. The WAV may receive the dispatch information through communication service 116. In some embodiments, the location of the passenger may be determined using location services, such as Global Positioning System (GPS), cellular networks, etc. Similarly, in some embodiments, the passenger may set the location. Accordingly, the location of the passenger may, in some scenarios, be different from an actual position of the passenger when the passenger submits the request.

At step 406, the remote computing system determines that the WAV has arrived at the location of the passenger. The remote computing system may utilize similar location services, cellular networks, etc. to determine a location of both the WAV and the location of the passenger.

At step 408, the remote computing system receives a request for the WAV to execute an ingress function. The request may be sent through a ridesharing application, such as ridesharing app 170. The request may then be received through a rideshare service, such as rideshare service 158. The remote computing system may then process the request and determine the ingress function. In some embodiments, the ingress function may include a deployment of a wheelchair ramp by the WAV and/or loading the wheelchair ramp after the passenger has boarded the WAV. Similarly, in some embodiments, the ingress function may include opening doors of the WAV and/or closing the doors of the WAV after the passenger has boarded the WAV. Likewise, in some embodiments, the ingress function may include engaging an automated restraint system configured to secure the wheelchair in the WAV. In some embodiments, the ingress function may be any combination of the above processes.

At step 410, the remote computing system sends an ingress command to the WAV in response to the request. In some embodiments, the remote computing system sends the command to the internal computing system of the WAV, which receives the command through a communication service, such as communication service 116. The ingress command comprises instructions to cause the WAV to execute the ingress function at a specified pick-up location, such as the location of the passenger.

At step 412, the remote computing system receives feedback from the WAV. As the WAV executes the ingress function, the WAV may send feedback to the remote computing system. In some embodiments, the WAV may send the feedback through a communication service, such as communication service 116. The feedback may include sensor data associated with a door to the WAV, a wheelchair ramp, and/or a wheelchair restraint system. For example, the sensor data may indicate that the wheelchair ramp is being unloaded. Similarly, the feedback may include status information associated with the ingress function. For example, the status information may indicate that a request has been received, that the WAV is executing the ingress function, that the WAV has completed the ingress function, that there is a fault state, etc.

At step 414, the remote computing system sends at least a portion of the feedback to the passenger of the WAV. In some embodiments, the remote computing system may send the feedback to the passenger through a rideshare service, such as rideshare service 158. Accordingly, the passenger will be aware of the status of the WAV executing the ingress function. In some embodiments, the remote computing system may send the status information associated with the ingress function to the passenger. In some embodiments, the remote computing system may send all of the feedback to the passenger.

In some embodiments, at step 416, the remote computing system determines that the status of the function includes a fault state. A fault state may be any state, in which the WAV is unable to complete the ingress function. For example, the WAV may include in the feedback, that a fault state has been detected because the sensors have detected an object passing by, such that the wheelchair ramp cannot be unloaded safely. As another example, the WAV may include in the feedback, that a fault state has been detected because the wheelchair should be moved a few inches to be properly restrained. Thus, the remote computing system can connect the passenger with a remote assistance operator. In some embodiments, the passenger may first resend the request. For example, the passenger may resent the request after moving the wheelchair in a suggested direction to be properly restrained. In some embodiments, the remote computing system may automatically connect the passenger with the remote assistance operator. The remote assistance operator may assist the passenger remotely. For example, the remote assistance operator may receive additional sensor data to determine the cause of the fault state. The remote assistance operator may then remotely send commands to the WAV to complete the ingress function.

At step 418, the remote computing system receives information from the passenger indicating readiness for the WAV to begin driving. In some embodiments, after the passenger has boarded the WAV and the wheelchair is properly secured and/or restrained, the passenger may send information to the remote computing system and/or the internal computing system of the WAV. In some embodiments, the passenger may send the information through a rideshare app, such as rideshare app 170, on the mobile device of the passenger. In some embodiments, the WAV may have sensors in the cabin of the vehicle to determine that the passenger is ready. For example, the WAV may have microphones, such that the WAV may determine that the passenger is ready if the passenger says, “I am ready.” In some embodiments, the ingress functions may include loading the ramp and closing the doors. In other embodiments, the internal computing system may, in response to determining that the passenger is ready, load the ramp, close the doors, and/or secure the wheelchair.

FIG. 8 shows a prior art method 500 for assisting passenger egress. It is contemplated in the prior art that method 500 may be used in conjunction with method 400 and/or alone. Method 500 starts at step 502, in which the remote computing system determines that the WAV has arrived at a destination. The remote computing system may utilize similar location services, cellular networks, etc. to determine a location of both the WAV and the location of the destination.

At step 504, the remote computing system sends an egress command to the WAV. The egress command includes egress instructions to cause the WAV to execute an egress function. In some embodiments, the remote computing system may send the egress command in response to receiving a request for the WAV to execute the egress function. The request may be sent through a ridesharing application, such as ridesharing app 170. The request may then be received through a rideshare service, such as rideshare service 158. The remote computing system may then process the request and determine the egress function. In some embodiments, the egress function may include a deployment of a wheelchair ramp by the WAV and/or loading the wheelchair ramp after the passenger has exited the WAV. Similarly, in some embodiments, the egress function may include opening doors of the WAV and/or closing the doors of the WAV after the passenger has exited the WAV. Likewise, in some embodiments, the egress function may include disengaging an automated restraint system configured to release the wheelchair in the WAV. In some embodiments, the egress function may be any combination of the above processes. In some embodiments, the remote computing system sends the command to the internal computing system of the WAV, which receives the egress command through a communication service, such as communication service 116. The egress command comprises instructions to cause the WAV to execute the egress function at a specified drop-off location, such as the destination.

At step 506, the remote computing system receives egress feedback from the WAV. As the WAV executes the egress function, the WAV may send egress feedback to the remote computing system. In some embodiments, the WAV may send the egress feedback through a communication service, such as communication service 116. The egress feedback may include egress sensor data associated with a door to the WAV, a wheelchair ramp, and/or a wheelchair restraint system. For example, the egress sensor data may indicate that the wheelchair ramp is being unloaded. Similarly, the egress feedback may include status information associated with the egress function. For example, the status information may indicate that a request has been received, that the WAV is executing the egress function, that the WAV has completed the egress function, that there is a fault state, etc.

At step 508, the remote computing system sends at least a portion of the egress feedback to the passenger of the WAV. In some embodiments, the remote computing system may send the egress feedback to the passenger through a rideshare service, such as rideshare service 158. Accordingly, the passenger will be aware of the status of the WAV executing the egress function. In some embodiments, the remote computing system may send the status information associated with the egress function to the passenger. In some embodiments, the remote computing system may send all of the feedback to the passenger.

In some embodiments, at step 510, the remote computing system determines that the status of the egress function includes a fault state. A fault state may be any state, in which the WAV is unable to complete the egress function. For example, the WAV may include in the egress feedback, that a fault state has been detected because the sensors have detected an object passing by, such that the wheelchair ramp cannot be unloaded safely. Thus, the remote computing system connects the passenger with a remote assistance operator. In some embodiments, the passenger may first resend the request. In some embodiments, the remote computing system may automatically connect the passenger with the remote assistance operator. The remote assistance operator may assist the passenger remotely. For example, the remote assistance operator may receive additional sensor data to determine the cause of the fault state. The remote assistance operator may then remotely send commands to the WAV to complete the egress function.

At step 512, the remote computing system receives information from the passenger indicating egress. In other words, the remote computing system receives information from the passenger that the passenger has fully disembarked from the WAV. In some embodiments, after the passenger has exited the WAV, the passenger may send information to the remote computing system and/or the internal computing system of the WAV. In some embodiments, the passenger may send the information through a rideshare app, such as rideshare app 170, on the mobile device of the passenger. In some embodiments, the WAV may have sensors on an exterior of the cabin of the vehicle to determine that the passenger has disembarked from the WAV. For example, the WAV may have cameras on an exterior of the WAV, such that the WAV may determine that the passenger has deboarded when the cameras detect the wheelchair has moved away from the wheelchair ramp. The WAV may then load the wheelchair ramp, close the doors, and begin a new rideshare journey.

FIG. 9 shows a map 600 of a property 602 for custom defining a behavior zone, according to some embodiments of the prior art. In particular, the map 600 shows a property 602 including a building 620 that has a main doorway 612 and a service doorway 616. Additionally, the map 600 shows a ramp 610 to the main door 612, with the bottom of the ramp marked as a wheelchair-accessible drop off location 608.

According to some implementations of the prior art, when a user accesses the map 600 through a portal and/or application, the user selects what type of behavior zone the user would like to add. In the map 600, the user may request to add alternative pick-up/drop-off locations and a wheelchair-accessible pick-up/drop-off location. If the main door entrance is a loading zone (no parking allowed), the user may request to add a loading zone identification. After identifying the type of behavior zone to be added, the user is asked to identify selected locations and to mark certain routes on the map 600.

In particular, to add the wheelchair-accessible pick-up/drop-off location 608, the user selects the corresponding behavior zone type, and then identifies the location 608 on the map 600. Additionally, if the mapping system for the behavior zones does not yet have the entry 604, the driveway 606, and/or the exit 614 mapped, the user will be prompted to identify these locations. After identifying the locations of the entry 604 and the exit 614, the user may be prompted to draw on the map 600 the route 606 from the entry 604 to the exit 614.

Other pick-up/drop/off locations may also be added to the map 600. To add other pick-up/drop-off locations, the user selects the corresponding behavior zone type (e.g., “alternative pick-up/drop-off location”), and then identifies the main door location 612 on the map 600. The user may also choose to identify the service entrance 616.

In some examples, the user can specify where vehicles should wait to pick-up a passenger. In particular, on the map 600, the standing area 618 is a space for vehicles to stand while awaiting passengers. The user can identify the standing area 618 on the map 600 by drawing an outline or circle around the area 618.

FIG. 10 illustrates an example prior art processor-based system with which some aspects of both the prior art and presently disclosed technology can be implemented. For example, processor-based system 700 that can be any computing device making up internal computing system 110, remote computing system 150 and/or a passenger device executing the rideshare app 170, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random-access memory (RAM) 725 to processor 710. Computing system 700 can include a cache of high-speed memory 712 connected directly with, in close proximity to, and/or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

Storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

FIG. 10 illustrates an example prior art processor-based system with which some aspects of the prior art and presently disclosed technology can be implemented. Specifically, FIG. 10 illustrates system architecture 700 wherein the components of the system are in electrical communication with each other using a bus 705. System architecture 700 can include a processing unit (CPU or processor) 710, as well as a cache 712, that are variously coupled to system bus 705. Bus 705 couples various system components including system memory 715, (e.g., read only memory (ROM) 720 and random access memory (RAM) 725, to processor 710.

System architecture 700 can include a cache of high-speed memory connected directly with, in close proximity to, or integrated as part of the processor 710. System architecture 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. Memory 715 can include multiple different types of memory with different performance characteristics. Processor 710 can include any general purpose processor and a hardware module or software module, such as module 1 (732), module 2 (734), and module 3 (736) stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction with the computing system architecture 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms. In some instances, multimodal systems can enable a user to provide multiple types of input to communicate with the computing system architecture 700. Communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

Storage device 730 can include software modules 732, 734, 736 for controlling processor 710. Other hardware or software modules are contemplated. Storage device 730 can be connected to the system bus 705. In one aspect, a hardware module that performs a particular function can include the software component stored in a computer-readable medium in connection with the necessary hardware components, such as the processor 710, bus 705, output device 735, and so forth, to carry out various functions of the disclosed technology.

Embodiments within the scope of the prior art and present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the prior art and present disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

### SUMMARY OF THE EMBODIMENTS

In one embodiment, a system is provided for facilitating ingress and egress of a wheelchair in a wheelchair accessible vehicle. The system may include: one or more processors; at least one door being moveable between an open position and a closed position; a wheelchair access device associated with one of the at least one door and being moveable between a deployed position and a stowed position; a wheelchair securement system for securing at least one of the wheelchair and a wheelchair passenger and having a secured condition and an unsecured condition; and, a non-transitory computer-readable medium coupled to the one or more processors. The computer readable medium can include instructions, which when executed by the one or more processors, cause the one or more processors to perform operations comprising: monitoring at least one of a vehicle status, a door status, a wheelchair access device status, a wheelchair securement system status, and a wheelchair status, wherein the wheelchair status comprises at least one of a location, a speed, and a direction of the wheelchair; and, initiating at least one interlock function that locks or unlocks at least one of the wheelchair accessible vehicle, one of the at least one doors, the wheelchair access device, and the wheelchair securement system based at least in part upon at least one of (a) the wheelchair status, (b) the door status, (c) the wheelchair access device status, (d) the wheelchair securement system status, and (e) the vehicle status.

In another embodiment, a computer-implemented method may be provided to perform the above-described operation.

### BRIEF DESCRIPTION OF DRAWINGS

FIG. 1 illustrates a system environment that can be used to facilitate AV navigation and routing operations, according to some aspects of the prior art and presently disclosed technology.

FIG. 2 illustrates an environment that includes a passenger entering a wheelchair-accessible autonomous vehicle, according to some aspects of the prior art and presently disclosed technology.

FIG. 3 and FIG. 4 illustrate environments during various steps of a passenger entering a wheelchair-accessible autonomous vehicle, according to some aspects of the prior art and presently disclosed technology.

FIG. 5 illustrates an accessibility system that facilitates AV ingress/egress of a wheelchair, according to some aspects of the prior art and presently disclosed technology.

FIG. 6 illustrates a prior art automated wheelchair ingress/egress process.

FIG. 7 illustrates a method for a passenger ingress process, according to some aspects of the prior art and presently disclosed technology.

FIG. 8 illustrates a method for a passenger egress process, according to some aspects of the prior art and presently disclosed technology.

FIG. 9 is a diagram illustrating a map of a property for defining a behavior zone, including a wheelchair pick-up/drop-off location, according to some embodiments of the prior art and present disclosure.

FIG. 10 illustrates a processor-based system with which some aspects of the prior art and presently disclosed technology can be implemented.

FIG. 11 illustrates an example environment in which a wheelchair accessible minivan includes a perception sensor for detecting an angle of a wheelchair ramp.

FIG. 12 illustrates an example environment in which a wheelchair accessible full-size van includes a perception sensor for detecting an angle of a wheelchair lift.

FIG. 13 illustrates the wheelchair lift of FIG. 12 in a ground-level position.

FIG. 14 illustrates an example environment in which the wheelchair accessible autonomous vehicle 102 of FIGS. 1-10 includes perception sensors for detecting an angle of a wheelchair access device.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

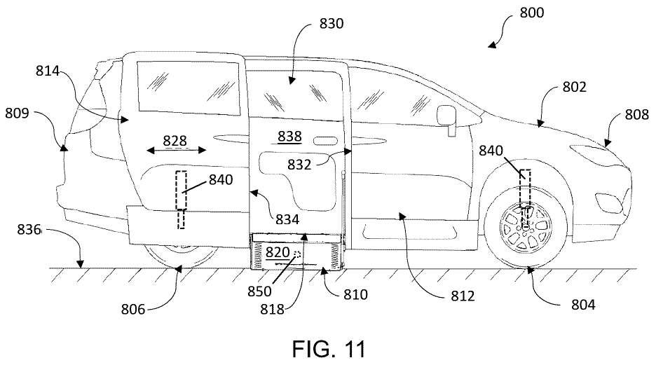

FIG. 11 illustrates an embodiment of a powered vehicle 802, specifically a minivan, available from any number of United States and foreign manufacturers, that has been modified to provide wheelchair access. The vehicle 802 may comprise a unibody construction. However, other vehicles contemplated within this disclosure may include a frame on body construction. Consequently, the use of the powered vehicle 802 herein includes all types and kinds of vehicles constructed with a body on frame construction, a unibody construction, or other constructions.

The vehicle 802 may include a vehicle body or chassis operatively coupled to front wheels 804 and rear wheels 806 which support the vehicle 802 as it traverses the ground. The front wheels 804 may define a front axle and the rear wheels 806 may define a rear axle of the vehicle 802.

The vehicle 802 includes a front end 808 and a rear end 809. A conventional driver's seat and front passenger seat (not shown) are generally located towards the front end 808 of the vehicle 802, whereas a rear passenger seat (not shown) is generally located towards the rear end 809 of the vehicle. More specifically, the vehicle 802 may include an interior that comprises a front interior portion and a rear interior portion. In several embodiments, the driver's seat and front passenger seat may be located in the front interior portion, and at least one rear passenger seat or at least one row of seats, usually two rows, may be located in the rear interior portion of the vehicle 802.

The vehicle 802 may include a first or front passenger side door 812 located between the front wheels 804 and rear wheels 806 and providing access to a passenger for sitting in a front passenger seat (not shown) of the vehicle 802 adjacent to the driver. In this position, the passenger has a clear forward view of the road when compared to sitting in the rear passenger seat of the vehicle 802. Moreover, when seated, the passenger may be facing in a forward direction of travel. Further, the vehicle 802 may include a second or rear passenger side door 814 coupled to the unibody frame.

The first door 812 and second door 814 may be hingedly coupled to the frame of the vehicle 802. In other embodiments, at least the second door 814 may be slidably coupled to the frame 802. In either case, door operation may be motorized to automatically move the door 812, 814 between an open position and a closed position. See, for example, U.S. Provisional Patent Application No. 63/491,552, filed on Mar. 22, 2023, which is incorporated herein by reference. In FIG. 11, the second door 814 is capable of being moved along a direction indicated by arrow 828 between an open position and a closed position. A user may grasp and manipulate a door handle to manually move the door 814 between the open and closed positions. In further embodiments, a key fob or other electrical control device (not shown) may send an electrical signal to a controller for moving the door 814 between its open and closed positions.

The second door 814 of the vehicle 802 is slidably coupled to the frame 802 of the vehicle 200. The vehicle frame may include one or more tracks upon which the door 814 is in a sliding engagement with as it moves between the open and closed positions. As the door 814 is moved to the open position, an opening 830 is created to provide access to the interior of the vehicle 802. The opening may be defined on the sides thereof by an edge 832 of a B-pillar and the edge 834 of the door 814 (or alternatively an edge of a C-pillar, hidden behind door 814).

The vehicle 802 may be further modified to include a ramp assembly 810 which provides rolling access of a wheelchair from pavement (or ground surface) 836 into an interior 838 of the vehicle. The ramp assembly 810 may installed at the opening 830, typically in a generally rectangular ramp cavity (or recessed) area in a lowered floor weldment. The ramp assembly 810 may include a ramp platform 820 that is moveable via a motor assembly between an interior 838 of the vehicle 802, where it may be stored below or generally flush with the floor 818 (a stowed position, likely parallel or generally/approximately parallel to the floor 818; i.e., generally horizontal when the vehicle is on level ground), and an exterior of the vehicle 802 for wheelchair access (in a deployed position), as shown in FIG. 11. When deployed, the ramp extends from the ground level 836 to the vehicle floor 918 level at an angle. In some ramp embodiments, the ramp platform may pivot upward as it moves to the stowed position, and possibly fold in half, whereby the ramp platform will have a stowed position that is perpendicular or generally/approximately perpendicular (i.e., generally vertical when the vehicle is on level ground) to the vehicle floor 818.

For the comfort and safety of the wheelchair passenger 250, it is preferred that the ramp angle or ratio with respect to horizontal be minimized in all directions (along the length of the ramp and side to said). While the ADA requires a ramp angle of no more than 14° (along the length of the ramp) with respect to horizontal, it has been found that a ramp angle of roughly 10.5° or less with respect to horizontal is preferred for the comfort of the user. The ramp angle is dependent upon a number of factors, including the level of the ground upon which the wheels 804, 806 rest and the level of the ground upon which the ground-end of the ramp platform 820 rests. For example, if the level of the ground near the ground-end of the platform 820 is lower than the ground upon which the vehicle wheels 804, 806 rest (for example, if the ground-end of the platform 820 rested in a pothole), then the angle of the ramp relative to horizontal will be greater than if the ground surrounding the vehicle and ramp were completely flat and horizontal. Similarly, if the level of the ground near the ground-end of the platform 820 is higher than the ground upon which the vehicle wheels 804, 806 rest (for example, if ground-end of the platform 820 sits on top of a curb), then the angle of the ramp relative to horizontal will be less than if the ground surrounding the vehicle and ramp were completely flat and horizontal.

In one embodiment, with the floor 818 being lowered from its original OEM position, the body or chassis of the vehicle 802 may be raised by adding one or more spacers or other components at or near a front axle and a rear axle of the vehicle 802. A kneeling system 840, comprising an air suspension or actuator, may additionally be installed to lower the vehicle floor 818 during wheelchair passenger ingress and egress. The dropping of the floor 818 and raising of the body or chassis 802 may provide additional headroom in the interior 838 or cab of the vehicle 802 so that a wheelchaired passenger has more room to move about within the vehicle 802. Moreover, the additional headroom allows a wheelchaired passenger to enter or exit the vehicle 802 more easily.

In known modified vehicles, such as the modified van 802, the middle row of seats may be removed from the manufacturer supplied vehicle to enable a passenger seated in a wheelchair to enter and exit the vehicle 802 using the ramp assembly 810. Once the wheelchaired passenger moves into the interior of the vehicle 802, the passenger or caregiver locates the wheelchair in the middle portion of the interior behind the driver and passenger seats of the front row. In other configurations, the wheelchaired passenger may be located in one of the front row seats.

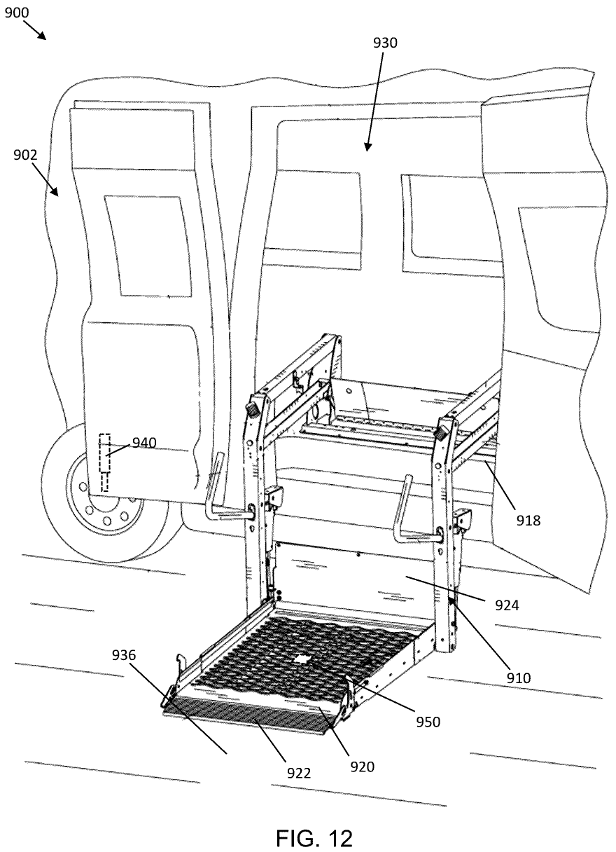

FIG. 12 illustrates the curb side of another commercially available, powered vehicle 902, a full-size van with many of the same features (e.g., doors, wheels, frame, etc.) as the minivan 802. The vehicle 902 has been modified for wheelchair access. Specifically, the vehicle 902 includes a different version of a wheelchair access device, a powered wheelchair lift 910, installed at a door opening 930. A kneeling system 940, comprising an air suspension or actuator, may additionally be installed to lower the vehicle floor 918 during wheelchair passenger ingress and egress.

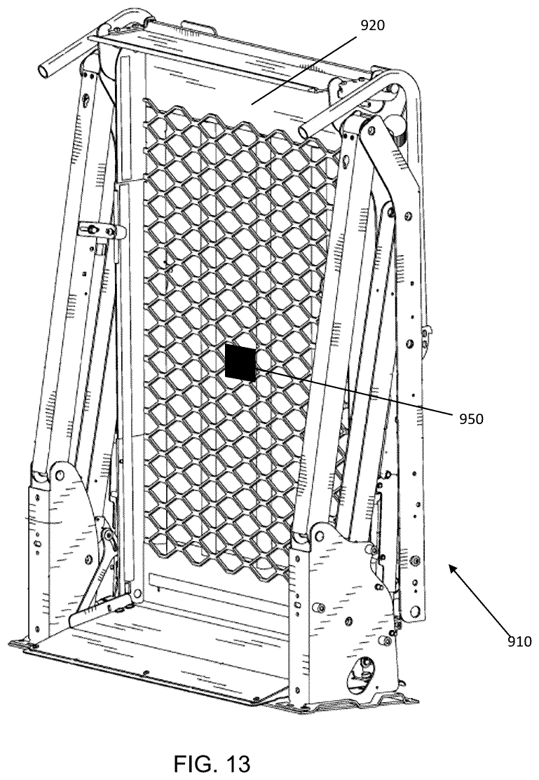

The lift 910 may be mounted to the floor 918 of the vehicle 902 and includes a lift platform 920. The lift platform 920 is moveable via a motor assembly (e.g., a hydraulic pump, actuators, etc.) between a stow position shown in FIG. 13, a ground level position shown in FIG. 12, and a vehicle floor level position (not shown). In the stow position, the lift platform 920 may be positioned vertically or generally/approximately vertical (i.e., when the vehicle is on level ground; generally perpendicular to the floor 918) to minimize the footprint of the lift assembly 910 in the vehicle 902. The lift platform 920 may be positioned in a horizontal or generally/approximately horizontal orientation (i.e., when the vehicle is on level ground; generally parallel to the floor 918) when located in the ground level position, whereby a wheelchair 250 can roll onto and off the lift platform 920 from/to the ground 936 at pick-up and drop off locations. Similarly, the lift platform 920 may be positioned horizontally or generally/approximately horizontal (i.e., when the vehicle is on level ground; generally parallel to the floor) at the vehicle floor level position, whereby a wheelchair can roll onto and off the lift platform 920 from/to the floor 918 of the vehicle 902 at pick-up and drop off locations. The lift 910 can include a parallelogram arm linkage assembly 915 or other mechanism for moving the lift platform 920 between the previously-mentioned positions. For the comfort and safety of the passenger, the linkage assembly 915 is intended to hold the lift platform 920 in a generally/approximately horizontal orientation (i.e., when the vehicle is on level ground; generally parallel to the floor 918) throughout the ingress/egress operation as the wheelchair 250 from the ground level position to the vehicle floor level position. However, uneven weight distribution on the lift can cause the platform 920 to diverge from the horizontal orientation, for example, if the wheelchair and/or passenger are not properly centered on the platform 920, or if the vehicle operator or caretaker elects to ride on the platform 920 with the wheelchair passenger (contrary to the user instructions and warnings by the lift manufacturer). Similarly, the platform 920 can diverge from the horizontal orientation during ingress/egress if the vehicle is not parked on level ground.

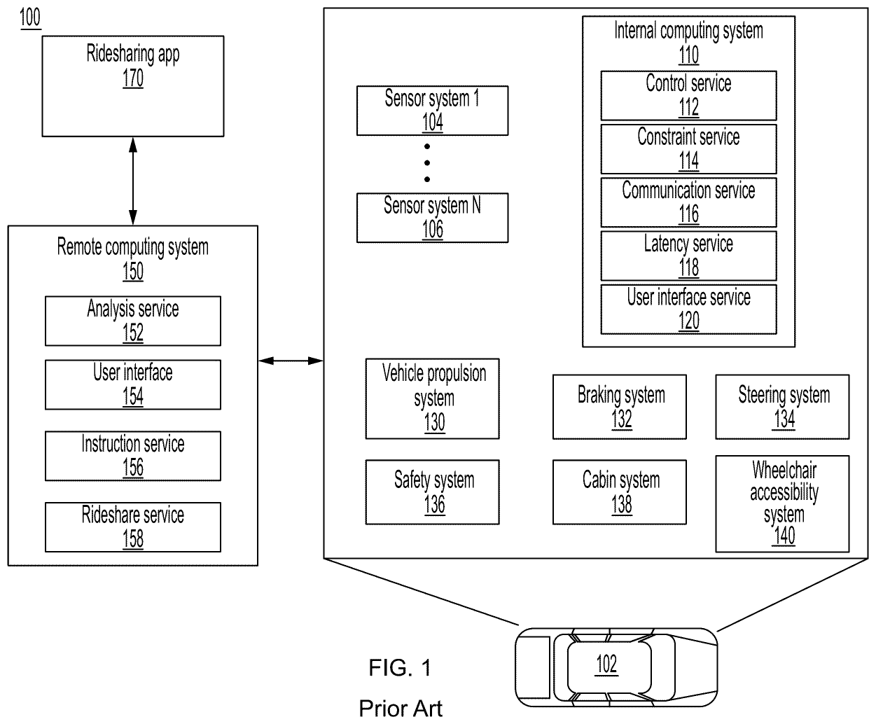

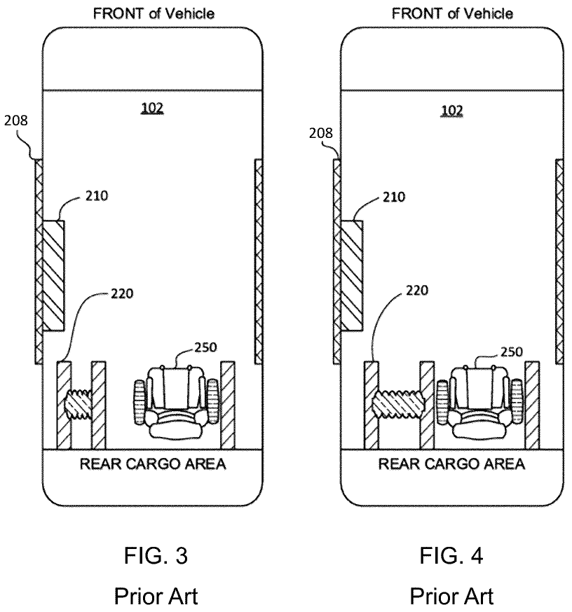

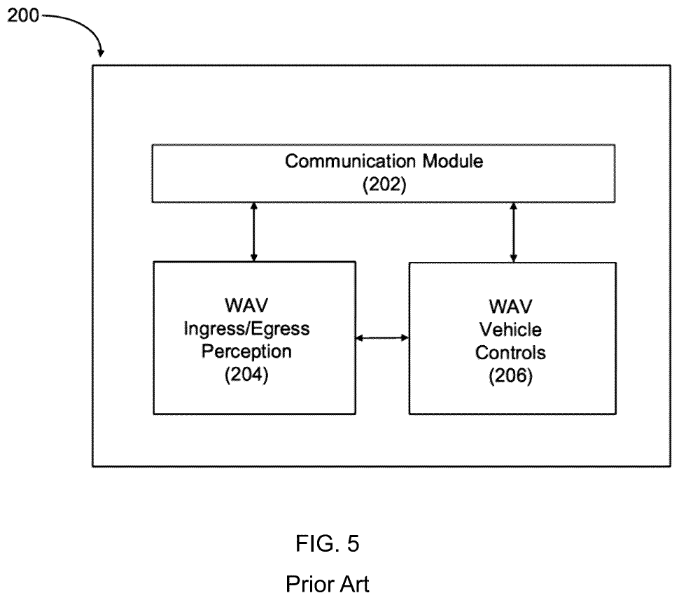

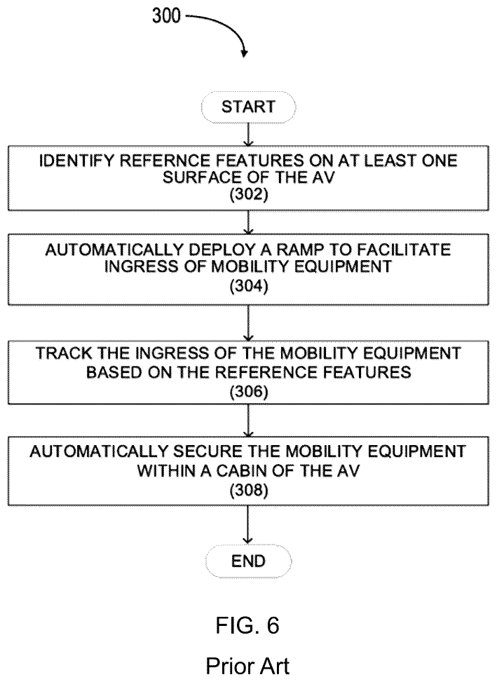

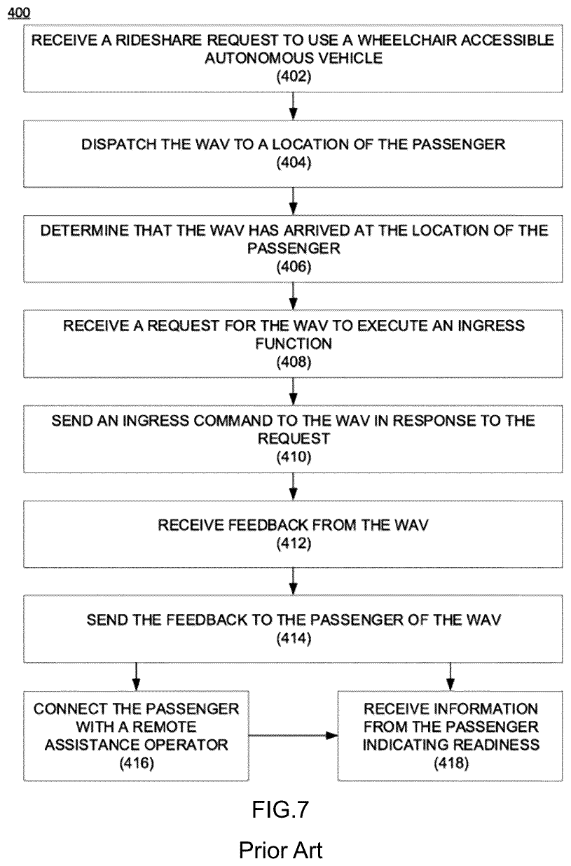

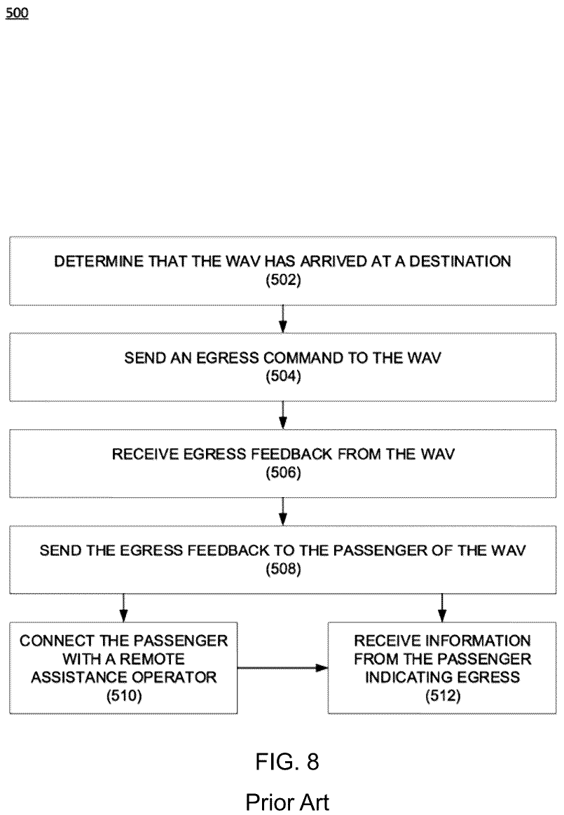

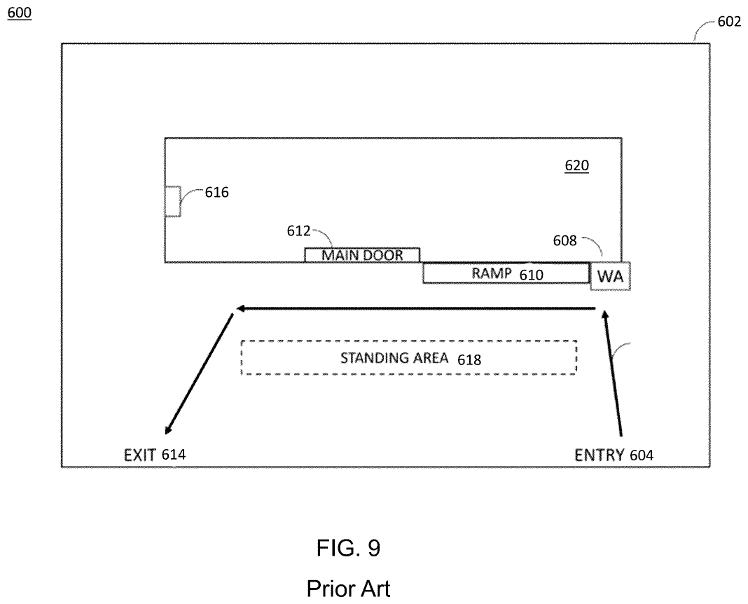

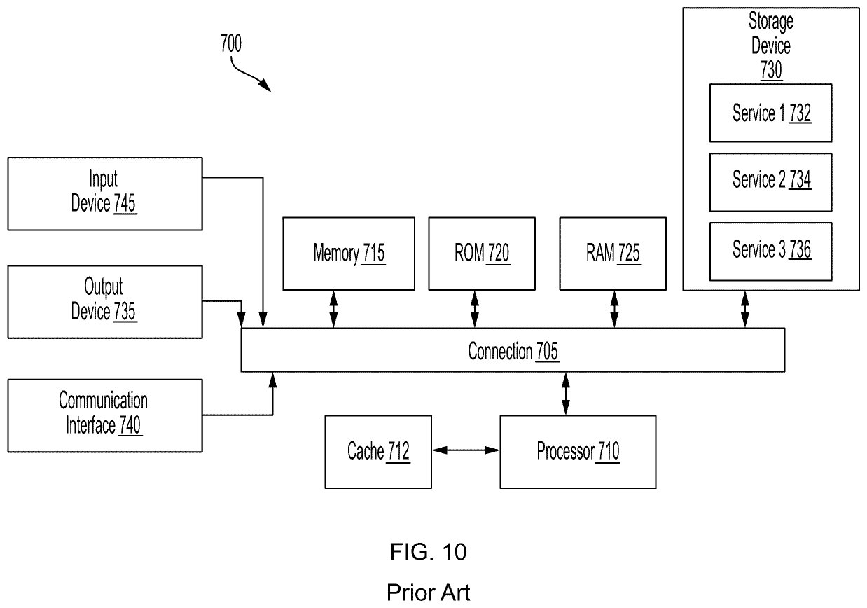

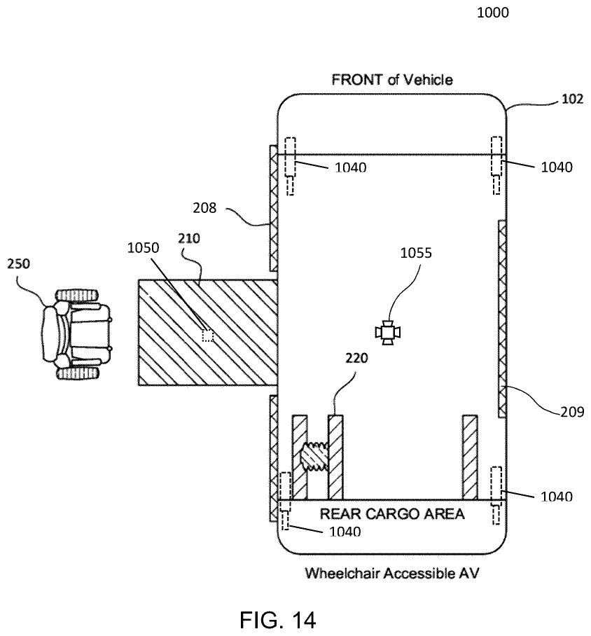

FIG. 14 illustrates an example environment 1000, in which the wheelchair accessible autonomous vehicle 102 of FIGS. 1-10 includes at least one perception sensor 1055 that is positioned to perceive the inside of the vehicle and a portion of the area outside of the vehicle near the ramp 210. Additional perception sensors 1055 may be positioned elsewhere in or on the outside of the vehicle to provide a wider field of view outside of the vehicle or provide views from different angles (for example, to view the wheelchair access device 210 from the side). A kneeling system 1040, comprising an air suspension or actuator, may additionally be installed to lower the vehicle floor during wheelchair passenger ingress and egress.

As described, FIGS. 11-13 illustrate example environments 800, 900 in which traditional wheelchair accessible vehicles 802, 902 can be improved by incorporating a system for confirming that safe ingress and egress conditions exist at pick-up and drop off locations. For instance, perception sensors 850, 950, may be utilized to determine the position and/or angle of the platforms 820, 920 particularly during ingress and egress. Moreover, responsive to output from those sensors, an alert system may be utilized to provide visual, auditory, tactile, or other alerts for the vehicle operator or caretaker of an unsafe condition. In yet other embodiments, controllers for accessibility subsystems (e.g., wheelchair access device, wheelchair securement system, doors, kneeling system, etc.) may adjust the operation of those subsystems in response to output from those sensors, for example, to take corrective action.

Similarly, FIGS. 1-10 and 14 illustrate various prior art systems, environments 1000, and processes for accommodating a wheelchair passenger 250 in an example autonomous vehicle (AV) 102, which may also be improved by incorporating a system for confirming that safe ingress and egress conditions exist at pick-up and drop off locations. The prior art embodiments of FIGS. 1-10 contemplate use of an accessibility system 200 and ingress/egress processes and methods 300, 400, 500 to enable “automatic” egress and ingress operations in AVs. However, the prior art ingress and egress operations are not truly automatic (for instance, they require input or other instructions from the wheelchair passenger), are vague in many respects, and lack sufficient disclosure to make and safely use wheelchair access devices in autonomous wheelchair accessible vehicle. As one example, the prior art disclosures do not include or contemplate safeguards or logic to ensure that the wheelchair access device (e.g., ramp) is oriented correctly for safe use by a wheelchair passenger. The shortcomings of the prior art AVs therefore can be addressed by the presently disclosed perception sensors 1055, 1050 and associated systems that can detect unsafe loading conditions, provide real time/immediate feedback to the vehicle control systems that are performing an automatic ingress or egress operation, provide real time/immediate feedback to the user via various displays in the vehicle and/or via an app on the user's personal mobile device, and generate appropriate control and/or safety interlocking of vehicle and accessibility subsystems.

The perception sensors 850, 950, 1055, 1050 may take form as a single sensor or multiple sensors comprising one or more of any of the following: an absolute position sensor, the camera sensor system 104, the Light Detection and Ranging sensor system (LIDAR) 106, and the other exemplary sensor systems described in the Background section above (e.g., RADAR, EmDAR, SONAR, SODAR, GNSS, GPS, accelerometers, gyroscopes, IMU, infrared, laser, ultrasonic, infrasonic sensor systems, microphones, etc.) and a Time-of-Flight sensor (ToF). The perception sensor 850, 950, 1055, 1050 may be mounted internal to the cabin of the vehicle (e.g., in the ceiling, a wall or door, the floor, etc.) and/or external to the vehicle and/or to any accessibility subsystem (e.g., the wheelchair securement system). As one example, the sensor 850, 950, 1050 may take form as an Adafruit 9-DOF [degrees of freedom] absolute orientation IMU Fusion Breakout sensor model BNO055 (see https://www.adafruit.com/product/2472 May 12, 2023) that may be secured to the wheelchair access device platform 820, 920, 210. As another example, the sensor 1055 may take form as a camera sensor system 104 that detects the orientation of the platform 820, 920, 210 using artificial intelligence/machine learning. Various sensors, including in different locations, may cooperate to ascertain the angle of the platform relative to earth. For example, an absolute position sensor could provide an indication of the vehicle's pitch, roll, and yaw relative to earth, while a camera sensor could provide an indication of the platform's pitch, roll, and yaw relative to the vehicle. With such information, the platform's pitch, roll, and yaw relative to earth can be determined.

With the use of an absolute position sensor (APS), the X, Y, and Z angles relative to the earth can be determined. Using that data, the XYZ of a lift platform, ramp, or door can be determined before it is deployed, opened/closed, or loaded.

In the case of a ramp 810, 210, any one or more of the XYZ angles relative to earth for the platform 820, 210 can be compared to a predetermined threshold angle to determine if the angle is not correct or safe for ingress/egress. Alternatively, the angle in the stowed condition can be compared to the angle at the deployed condition. If the difference exceeds a predetermined threshold, the system can determine that an unsafe condition exists. Unsafe conditions could include if the ramp was too steep (in a hole perhaps) or if it were at too extreme of an angle right to left of the platform 820, 210. The system could then generate a signal for use in another device, or have an internal alarm, to alert the user of the unsafe conditions. The threshold angles/differences can be set/predetermined by the vehicle or subsystem manufacturer/installer and/or by the vehicle operator, wheelchair passenger, or caretaker through onboard input devices or apps on personal mobile devices.

Similarly, in the case of a lift 910, any one or more of the XYZ angles relative to earth for the platform 920 can be compared to a predetermined threshold angle to determine if the angle is not correct or safe for ingress/egress. Alternatively, the angles at floor and ground level can be measured before the occupant is loaded, and then again after the occupant boards the platform. In the instance of floor level, the system should be able to compare the difference in angles to a predetermined threshold right away once the occupant boards the platform 920 to determine if it is improperly loaded, whereas at ground level the system may have to wait for the platform 920 itself to leave the ground before the difference can be computed. If the platform exceeds the set angle threshold in any of the 3 directions, then operation could be prevented, halted, or reversed and an alert can be generated. The threshold angles/differences can be set/predetermined by the vehicle or subsystem manufacturer/installer and/or by the vehicle operator, wheelchair passenger, or caretaker through onboard input devices or apps on personal mobile devices.

In a sliding door 814 system, the angle at which the vehicle is pointed can be determined (nose up/nose down) based on the angle of the wheelchair access device in the stow position (or based on a vehicle-mounted perception sensor). In a nose down situation on the open cycle (with the door moving toward a rear of the vehicle), the door motor can be run with full force as opposed to slowing it down near the end of travel (which happens on standard operation). On the close cycle, the door motor can be run with reduced force. More generally speaking, when the door is moving uphill, motor speed, current, voltage, or power can be increased. When the door is moving downhill, motor speed, current, voltage, or power can be decreased. Voltage from can be effectively varied though use of PWM, pulse width modulation (e.g., rather than a constant 12V from the vehicle battery).

The perception sensor 850, 950, 1050, 1055 may be used to ascertain if the Lift/Ramp platform 820, 920, 210 is loaded correctly (e.g., appropriately weight balanced) or in a safe angle for ingress/egress. The perception sensor 850, 950, 1050, 1055 is configured to determine tilt to ensure the user is safely loaded as well as the angle of a ramp so that the user knows they are at a safe angle to enter/exit the vehicle. In some embodiments, the perception sensor 850, 950, 1050, 1055 sensor provides the absolute XYZ angles in relation to the earth. Use of the perception sensor 850, 950, 1050, 1055 will benefit customer safety and potentially wear and tear of lift units in the field.

In the event that the perception sensor 850, 950, 1050, 1055 indicates an unsafe condition (i.e., unsafe angle, unbalanced weight, etc.), a controller may be configured to stop or reverse motion of the wheelchair access device 810, 910, 210. Additionally, an alarm can be triggered to elicit corrective action from the vehicle operator or caretaker. Additionally, unsafe conditions can be communicated to the vehicle, for instance to the vehicle CAN or other communication bus via a gateway module or direct connection, whereby the vehicle can provide visual, audible, or tactile alerts for the vehicle operator or caretaker. Further yet, one or more of the angles of the wheelchair access device and/or unsafe conditions can be communicated visually, audibly, or tactilely to the user through displays, speakers, or other devices in the vehicle or through an app on the user's personal mobile device.

In environment 1000, angle status/feedback from the perception sensor 1050, 1055 may be provided to any one or more of the remote computing system 150, the ride sharing app 170, the wheelchair passenger 250, other vehicle occupants, and other persons standing near the vehicle 102, through audible, visual or tactile alerts and/or pursuant to operation 400, including but not limited to steps 414, 416, and 418 and/or pursuant to operation 500, including but not limited to steps 508, 510, and 512. Additionally or alternatively a computing system (for instance, the internal computing system 110) may be configured to identify fault states based on input from perception sensors 1050, 1055 and/or provide feedback of such fault states to any one or more of the remote computing system 150, the ride sharing app 170, the wheelchair passenger 250, other vehicle occupants, and other persons standing near the vehicle 102, including through audible, visual, or tactile alerts and/or pursuant to operation 400, including but not limited to steps 414, 416, and 418, and/or pursuant to operation 500, including but not limited to steps 508, 510, and 512.

The perception sensor 850, 950, 1010, 1055 has additional utility outside of ingress/egress operations. For instance, the perception sensor 850, 950, 1050, 1055 can be utilized to confirm that a wheelchair access device, 810, 910, 210 stays in the intended stow position (e.g., vertical in FIG. 13) when not being utilized. Information from the perception sensor 850, 950, 1050, 1055 can also be used to speed the door up or slow it down, or increase/decrease motor force/power/voltage/current, according to the direction the door is moving and the corresponding angle at which its traveling (uphill or downhill). The speed/power/force/current can be variably applied in correlation to the angle magnitude. Adding such an algorithm to the door control system would prevent the need to overpower the door in all applications to account for worst case ground angles saving unnecessary wear and tear on the door subsystem components.

In some embodiments, maps (e.g., behavior maps 600) used by the vehicle and/or rideshare app (e.g., maps stored/used in internal computing system 110 memory, stored/used by the remote computing system 150, or stored/used in the rideshare service 158) may be updated to include information from the perception sensor 850, 950, 1050, 1055. For instance, possible pick-up/drop-off locations (e.g., location 608) may be color-coded based on the angle of the platform 820, 920, 210 during previous pick-up(s)/drop-off(s) so that a rider can make an informed decision on an ideal pick-up/drop-off location. For instance, at any given location, the map could be marked with a red color if the ramp platform 820, 210 angle was equal to or exceeded a predetermined safety threshold (e.g., 14°), a yellow color if the angle above a predetermined comfort threshold and below the predetermined safety threshold (e.g., between 10.5° and 14°), and green if the angle was equal to or below the predetermined comfort threshold. Alternatively and more simply, possible pick-up/drop-off locations can be marked as either suitable or unsuitable for wheelchair ingress/egress. In some embodiments, safety and comfort thresholds can be set/predetermined by the vehicle or subsystem manufacturer/installer. In other embodiments, safety and comfort thresholds can be set/predetermined by the vehicle operator, wheelchair passenger, or caretaker.

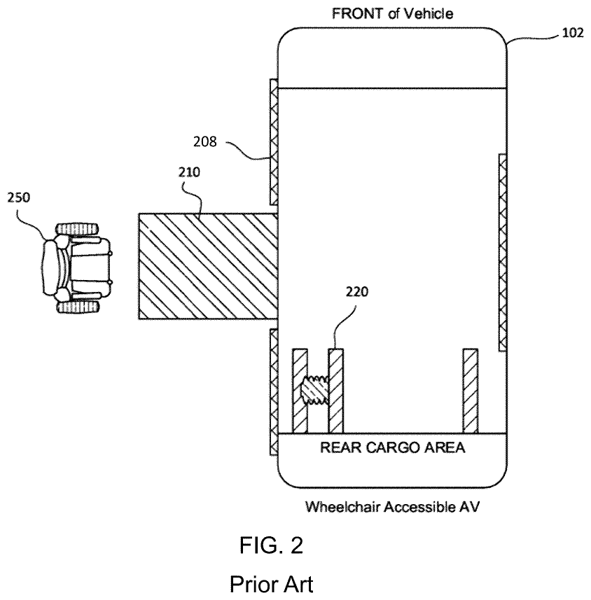

Aside from detecting unsafe platform angles, perception sensor 950 for wheelchair lift 910 may be utilized to detect unsafe loading conditions on the platform 920 both during ingress and egress. For instance, during ingress, a lift controller (not shown) can set a baseline angle to be equal to the angle of the platform 920 when it is located in the ground-level position, prior to loading of the wheelchair (for example, while the outboard barrier 922 is in its raised position). After the outboard barrier 922 moves to its lowered position shown in FIG. 2 and/or after the wheelchair passenger 250 has been received on the platform 920 and the platform 920 begins to move upward toward the floor-level position, the lift controller can monitor the difference between the platform angle and the baseline angle. A departure between the two angles can be indicative of an unbalanced (off center) loading condition (or than a caretaker/vehicle operator is impermissibly riding on the platform 920 with the wheelchair passenger). When the difference between the two angles exceeds a threshold difference, corrective action can be taken consistent with the above-described methods for correcting an unsafe platform angle. In one embodiment, the lift 910 can be configured to lift the vehicle a small distance above the ground 936. If an unbalanced loading condition is detected, the lift controller can reverse direction and lower the platform 920 to the ground, and interlock operation of the lift 910 until the unbalanced loading condition is corrected.

Similarly, during egress, the lift controller can set a baseline angle to be equal to the angle of the platform 920 when it is located in the floor-level position, prior to loading of the wheelchair for example, while the outboard barrier 924 is in its raised position). Immediately after the outboard barrier 924 moves to its lowered position and/or after the wheelchair passenger 250 has been received on the platform 920 (and alternatively after the platform 920 begins to move downward toward the ground-level position), the lift controller can monitor the difference between the platform angle and the baseline angle. A departure between the two angles can be indicative of an unbalanced (off center) loading condition. When the difference between the two angles exceeds a threshold difference, corrective action can be taken consistent with the above-described methods for correcting an unsafe platform angle. In one embodiment, the lift 910 may be interlocked preventing operation until the unbalanced loading condition is corrected.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A wheelchair access device for facilitating ingress and egress of a wheelchair passenger into and out of a wheelchair accessible vehicle, the wheelchair access device comprising:
a platform for receiving the wheelchair passenger; and,
a perception sensor outputting a signal indicative of at least one angle of the platform relative to horizontal.

2. The wheelchair access device of claim 1, wherein the perception sensor is for ensuring the at least one angle does not violate a threshold angle.

3. The wheelchair access device of claim 2 further comprising at least one indicator configured to provide an alert when the at least one angle violates the threshold angle.

4. The wheelchair access device of claim 3, wherein the alert comprises at least one of a visual alert, an auditory alert, and a tactile alert.

5. The wheelchair access device of claim 1, wherein the wheelchair access device is a wheelchair lift.

6. The wheelchair access device of claim 5, further comprising a controller for moving the platform between a stow position, a ground level position and a vehicle floor level position, the controller being configured to receive the signal and interrupt movement of the platform when the at least one angle violates the threshold angle.

7. The wheelchair access device of claim 5, further comprising a controller for moving the platform between a stow position, a ground level position and a vehicle floor level position, the controller being configured to receive the signal and prevent movement of the platform when the at least one angle violates the threshold angle.

8. The wheelchair access device of claim 6, wherein the controller is configured to interrupt movement of the platform by at least one of stopping movement and reversing a direction of movement.

9. The wheelchair access device of claim 5, wherein the threshold angle is approximately 3° relative to horizontal.

10. The wheelchair access device of claim 9, further comprising at least one indicator configured to provide an alert when the at least one angle violates the threshold angle, wherein the indicator is configured to provide the alert when the at least one angle exceeds the threshold angle.

11. The wheelchair access device of claim 5, further comprising at least one controller for moving the platform between a stow position, a ground level position and a vehicle floor level position, wherein the at least one controller is configured to: receive the signal; set at least one baseline angle based on the at least one angle of the platform when the platform is unloaded and at one of a floor level position and a ground level position; monitor a difference between the at least one baseline angle and the at least one angle of the platform; and take a corrective action if the difference exceeds a threshold difference.

12. The wheelchair access device of claim 1, wherein the wheelchair access device is a wheelchair ramp.

13. The wheelchair access device of claim 12, wherein the threshold angle is approximately 14° relative to horizontal.

14. The wheelchair access device of claim 13, further comprising at least one indicator configured to provide an alert when the at least one angle violates the threshold angle.

15. The wheelchair access device of claim 12, further comprising at least one controller for moving the platform between a stow position and a deployed position, the at least one controller being configured to: receive the signal; set at least one baseline angle based on the at least one angle of the platform when the platform is in the stow position; monitor a difference between the at least one baseline angle and the at least one angle of the platform; and take a corrective action if the difference exceeds a threshold difference.

16. The wheelchair access device of claim 1, wherein the perception sensor is disposed on the platform.

17. The wheelchair access device of claim 1, wherein the perception sensor comprises an absolute position sensor.

18. The wheelchair access device of claim 1, wherein the perception sensor comprises one or more of a camera sensor, a LiDAR sensor, a ToF sensor, RADAR sensor, a EmDAR sensor, a SONAR sensor, a SODAR sensor, a GNSS sensor, an accelerometer sensor, a gyroscope sensor, an IMU sensor, an infrared sensor, a laser rangefinder sensor, an ultrasonic sensor, an infrasonic sensor, and a microphone.

19. The wheelchair access device of claim 1, further comprising a communication device for outputting information based on the signal.

20. A wheelchair accessible vehicle comprising:
a wheelchair access device for facilitating ingress and egress of a wheelchair passenger into and out of the wheelchair accessible vehicle, the wheelchair access device having a platform for receiving the wheelchair passenger; and,
a perception sensor outputting a signal indicative of at least one angle of the platform relative to horizontal.
